(19) United States
(12) Patent Application Publication
(10) Pub. No.: US 2007/0098932 A1
(43) Pub. Date: May 3, 2007

(54) Anticorrosive paper or paperboard material

(76) Inventors: Richard F. Rudolph, Mason, OH (US); Bernhard F. Reumuller, Grosse Ile, MI (US); Jamie Hill, Farmington Hills, MI (US)

Correspondence Address: INTERNATIONAL PAPER COMPANY, 6285 TRI-RIDGE BOULEVARD, LOVELAND, OH, 45140, US

(21) Appl. No.: 11/590,119

(22) Filed: Oct. 31, 2006

Related U.S. Application Data
(60) Provisional application No. 60/731,897, filed on Oct. 31, 2005.

(51) Int. Cl. B32B 27/10

(52) U.S. Cl. 428/34.2; 428/182

(57) ABSTRACT

The present invention relates to an anticorrosive paper or paperboard substrate, as well as methods of making and using the same.

The present application claims the benefit of priority under 35 USC §119(e) to U.S. Provisional Patent Application 60/731,897, filed Oct. 31, 2005, which is hereby incorporated, in its entirety, herein by reference.

### FIELD OF THE INVENTION

The present invention relates to an anticorrosive paper or paperboard substrate, as well as methods of making and using the same.

### BACKGROUND OF THE INVENTION

International transportation of products sensitive to corrosion in various aqueous-containing atmospheres is a very vast and lucrative commercial market. In order for products sensitive to corrosion to be able to withstand such environments that are highly fluctuating in temperature and their moisture content (e.g. Relative Humidity), it is possible to coat the products with anticorrosive materials that aid in the reduction of such products' sensitivity to corrosion. However, such coatings that are applied directly onto the products are messy and/or could compromise the end functionality of the product just as much as corrosion, itself, could bestow on the products.

Examples of corrosive atmospheres are those having high temperature and/or high relative humidity. Further, of corrosive atmospheres may include those containing water vapor, salt air, carbon dioxide, sulfur dioxide, hydrogen sulfide, or other gases which pose a threat to surfaces of, for example, metallic objects.

In light of the above, there is a desire for a low cost manner of reducing the corrosive effects that a vast array of environments may produce on products sensitive to corrosiveness during shipping, especially in a manner that does not compromise the end functionality or use or aesthetics of such products.

### BRIEF DESCRIPTION OF THE DRAWINGS

FIG. 1: A first schematic cross section of just one exemplified embodiment of the paper substrate that is included in the paper substrate of the present invention.

FIG. 2: A second schematic cross section of just one exemplified embodiment of the paper substrate that is included in the paper substrate of the present invention.

FIG. 3: A third schematic cross section of just one exemplified embodiment of the paper substrate that is included in the paper substrate of the present invention.

FIG. 4: A fourth schematic cross section of just one exemplified embodiment of the paper substrate that is included in the paper substrate of the present invention.

FIG. 5: A fifth schematic cross section of just one exemplified embodiment of the paper substrate that is included in the paper substrate of the present invention.

FIG. 6: A first preferred embodiment of a package made of the paper or paperboard of the present invention.

FIG. 7: A second preferred embodiment of a package made of the paper or paperboard of the present invention.

FIG. 8: A photograph showing the surfaces of carbon steel coupons stored in contact with conventional build up block (BUB) made from conventional substrates under 90% Relative Humidity/100° F. for two weeks in a package of the present invention made by a substrate of the present invention compared to those coupons stored under similar conditions in a conventional packages containing conventional substrates.

FIG. 9: Images showing the surfaces of aluminum coupons stored in contact with conventional build up block (BUB) made from conventional substrates under 90% Relative Humidity/100° F. for two weeks in a package of the present invention made by a substrate of the present invention compared to those coupons stored under similar conditions in a conventional package containing conventional substrate.

FIG. 10: Images of the surfaces of three carbon steel coupons stored in contact with conventional build up block (BUB) made from conventional substrates and stored under 90% Relative Humidity/100° F. in a conventional package containing conventional substrate.

FIG. 11: Images of the surfaces of three carbon steel coupons stored in contact with a build up block (BUB) of the present invention made from a substrate of the present invention containing low, medium, and high dosages of Cortec VPCi 350 AHS and stored under 90% Relative Humidity/100° F. in a conventional package containing conventional substrate.

FIG. 12: Images of the surfaces of three carbon steel coupons stored in contact with a build up block (BUB) of the present invention made from a substrate of the present invention containing low, medium, and high dosages of NTIC #6122A and stored under 90% Relative Humidity/100° F. in a conventional package containing conventional substrate.

FIG. 13: Images of the surfaces of three carbon steel coupons stored in contact with a build up block (BUB) of the present invention made from a substrate of the present invention containing very low and low dosages of Progressive #V-983 and stored under 90% Relative Humidity/100° F. in a conventional package containing conventional substrate.

FIG. 14: Images of the surfaces of three carbon steel coupons stored in contact with a build up block (BUB) of the present invention made from a substrate of the present invention containing medium and high dosages of Progressive #V-983 and stored under 90% Relative Humidity/100° F. in a conventional package containing conventional substrate.

FIG. 15: Images of the surfaces of three carbon steel coupons stored in contact with a build up block (BUB) of the present invention made from a substrate of the present invention containing low, medium, and high dosages of SpectraGuard 763 AVCI and stored under 90% Relative Humidity/100° F. in a conventional package containing conventional substrate.

### DETAILED DESCRIPTION OF THE INVENTION

The present inventors have discovered a paper or paperboard substrate that is capable to aid in combating the corrosion of products sensitive to such corrosion when used in packaging materials for the products.

The paper substrate contains a web of cellulose fibers. The source of the fibers may be from any fibrous plant. The paper substrate of the present invention may contain recycled fibers and/or virgin fibers. Recycled fibers differ from virgin fibers in that the fibers have gone through the drying process at least once.

The paper substrate of the present invention may contain from 1 to 99 wt %, preferably from 5 to 95 wt %, cellulose fibers including 1, 5, 10, 15, 20, 25, 30, 35, 40, 45, 50, 55, 60, 65, 70, 75, 80, 85, 90, 95 and 99 wt %, and including any and all ranges and subranges therein.

Preferably, the sources of the cellulose fibers are from softwood and/or hardwood. The paper substrate of the present invention may contain from 1 to 100 wt %, preferably from 5 to 95 wt %, cellulose fibers originating from softwood species based upon the total amount of cellulose fibers in the paper substrate. This range includes 1, 2, 5, 10, 15, 20, 25, 30, 35, 40, 45, 50, 55, 60, 65, 70, 75, 80, 85, 90, 95, and 100 wt % cellulose fibers originating from softwood species, including any and all ranges and subranges therein, based upon the total amount of cellulose fibers in the paper substrate.

The paper substrate of the present invention may contain from 1 to 100 wt %, preferably from 5 to 95 wt %, cellulose fibers originating from hardwood species based upon the total amount of cellulose fibers in the paper substrate. This range includes 1, 2, 5, 10, 15, 20, 25, 30, 35, 40, 45, 50, 55, 60, 65, 70, 75, 80, 85, 90, 95, and 100 wt % cellulose fibers originating from hardwood species, including any and all ranges and subranges therein, based upon the total amount of cellulose fibers in the paper substrate.

When the paper substrate contains both hardwood and softwood fibers, it is preferable that the hardwood/softwood ratio be from 0.001 to 1000. This range may include 0.001, 0.002, 0.005, 0.01, 0.02, 0.05, 0.1, 0.2, 0.5, 1, 2, 5, 10, 15, 20, 25, 30, 35, 40, 45, 50, 55, 60, 65, 70, 75, 80, 85, 90, 95, 100, 200, 300, 400, 500, 600, 700, 800, 900, and 1000 including any and all ranges and subranges therein and well as any ranges and subranges therein the inverse of such ratios.

Further, the softwood and/or hardwood fibers contained by the paper substrate of the present invention may be modified by physical and/or chemical means. Examples of physical means include, but is not limited to, electromagnetic and mechanical means. Means for electrical modification include, but are not limited to, means involving contacting the fibers with an electromagnetic energy source such as light and/or electrical current. Means for mechanical modification include, but are not limited to, means involving contacting an inanimate object with the fibers. Examples of such inanimate objects include those with sharp and/or dull edges. Such means also involve, for example, cutting, kneading, pounding, impaling, etc means.

Examples of chemical means include, but is not limited to, conventional chemical fiber modification means including crosslinking and precipitation of complexes thereon. Examples of such modification of fibers may be, but is not limited to, those found in the following patents U.S. Pat. Nos. 6,592,717, 6,592,712, 6,582,557, 6,579,415, 6,579,414, 6,506,282, 6,471,824, 6,361,651, 6,146,494, H1,704, 5,731,080, 5,698,688, 5,698,074, 5,667,637, 5,662,773, 5,531,728, 5,443,899, 5,360,420, 5,266,250, 5,209,953, 5,160,789, 5,049,235, 4,986,882, 4,496,427, 4,431,481, 4,174,417, 4,166,894, 4,075,136, and 4,022,965, which are hereby incorporated, in their entirety, herein by reference.

The paper substrate of the present invention may contain recycled or virgin (i.e. new and/or unused) fibers. The substrate may contain any amount of virgin fibers based upon the total weight of cellulose fibers in the substrate. In one embodiment, the substrate may contain from 0 to 100% virgin fibers, preferably from 80 to 100 wt % virgin fibers based upon the total weight of cellulose fibers in the substrate. In a separate embodiment, the substrate may preferably contain from 50 to 0 wt % virgin fibers, more preferably from 10 to 20 wt % virgin fibers based upon the total weight of cellulose fibers in the substrate. This range includes 0, 5, 10, 15, 20, 25, 30, 35, 40, 45, 50, 55, 60, 65, 7-, 75, 80, 85, 90, 95, and 100 wt % virgin fibers based upon the total weight of cellulose fibers in the substrate, including any and all ranges and subranges therein.

The paper substrate of the present invention may contain recycled fibers. Sources of such recycled fiber, for example, may be provided within streams containing “fine”, which may also be found in SaveAll fibers, recirculated streams, reject streams, waste fiber streams. The amount of “fines” present in the paper substrate can be modified by tailoring the rate at which such streams are added to the paper making process.

The paper substrate preferably contains a combination of hardwood fibers, softwood fibers and “fines” fibers. “Fines” fibers are, as discussed above, recirculated and are typically not more that 100 μm in length on average, preferably not more than 90 μm, more preferably not more than 80 μm in length, and most preferably not more than 75 μm in length. The length of the fines are preferably not more than 5, 10, 15, 20, 25, 30, 35, 40, 45, 50, 55, 60, 65, 70, 75, 80, 85, 90, 95, and 100 μm in length, including any and all ranges and subranges therein.

The paper substrate may contain any amount of fines and/or recycled fibers based upon the total amount of cellulose fibers. The paper substrate may contain from 0 to 100 wt % fines and/or recycled fibers. In one embodiment, the paper substrate contains from 0 to 25 wt % fines and/or recycled fibers, preferably from 0 to 20 wt % fines and/or recycled fibers based upon the total weight of cellulose fibers in the substrate. In another embodiment, the substrate contain greater than 80 wt % to 100 wt %, preferably from 80 to 90 wt % fines and/or recycled fibers based upon the total weight of cellulose fibers. This range includes 0, 0.01, 0.05, 0.1, 0.2, 0.5, 1, 2, 3, 4, 5, 6, 7, 8, 9, 10, 12, 15, 20, 25, 30, 35, 40, 45, 50, 55, 60, 65, 70, 75, 80, 85, 90, 95 and 100 wt % fines and/or recycled fibers fibers based upon the total weight of cellulose fibers in the substrate, including any and all ranges and subranges therein.

The paper substrate may alternatively or overlappingly contain from 0.01 to 100 wt % fines and/or recycled fibers, preferably from 0.01 to 50 wt %, most preferably from 0.01 to 15 wt % based upon the total weight of the fibers contained by the paper substrate. The paper substrate contains not more than 0.01, 0.05, 0.1, 0.2, 0.5, 1, 2, 3, 4, 5, 6, 7, 8, 9, 10, 12, 15, 20, 25, 30, 35, 40, 45, 50, 55, 60, 65, 70, 75, 80, 85, 90, 95 and 100 wt % fines and/or recycled fibers based upon the total weight of the fibers contained by the paper substrate, including any and all ranges and subranges therein.

The paper substrate may also contain an anticorrosive material. An anticorrosive material is one that helps inhibit, reduce, slow down, the rate of corrosion on a corrosion-sensitive product to which it is applied and/or on a product to which it is placed nearby. Examples of anticorrosive material may be amine salts, 2-amino-2-methyl-1-propanol, anhydrous ammonia, ammonium benzoate, alkali molybdates, alkali nitrites, alkali dibasic acid salts, triazole-containing compounds, sodium molybdate, dicyclohexylammonium nitrate, sodium nitriate, sodium nitrite, cyclohexylammonium benzoate, ethanol ammonium benzoate, benzotriazole, triethanolammonium nitrate, sodium benzoate, sodium sebacate, tolytriazole, tall oil imidazoline acetate, tall oil imidazoline nitrate, cyclohexyammonium p-nitro benzoate, ammonium salt of sebacic acid, monoethanolammonium benzoate, potassium molybdate, lauric diethanolamide, ammonium salts.

Some preferred anticorrosive materials are those that are volatile and/or vapor corrosion inhibitors (i.e. VCI), such as those contained in commercially available products from Michelman Incorporated, Progressive Coating Inc., Northern Technologies International Corp., Spectra-kote Corporation, and Cortec Corporation, for example (e.g. VCI-350 AHS from Cortec Corporation; Rustban 250 from Michelman Incorporated; Progressive V-983 from Progressive Coatings Inc.; NTIC #6122A and Zerustg products from Northern Technologies International Corp.; and Spectra-Guard 763-AVCI from Spectra-kote Corporation). Further examples of anticorrosive materials may be found in U.S. Pat. Nos. 6,833,334; 6,617,415; 6,555,600; 6,444,595; 6,420,470; 6,331,044; 6,292,996; 6,156,929; 6,132,827; 6,054,512; 6,028,160; 5,937,618; 5,896,241; 5,889,639; 5,773,105; 5,736,231; 5,715,945; 5,712,008; 5,705,566; 5,486,308; 5,391,322; 5,324,448; 5,139,700; 5,209,869; 5,344,589; 4,313,836; 4,312,768; 4,151,099; 4,101,328; 6,429,240; 6,273,993; 6,255,375; and 4,685,563, which are hereby incorporated, in their entirety, herein by reference.

Volatile and/or Vapor-phase corrosion inhibitors (VCI and/or VpCI together hereon as VCI where denoted) are products containing anticorrosive materials such as those chemistries mentioned above and are able inhibit, reduce, slow the rate of corrosion on corrosion-sensitive products when placed on and/or near the corrosion sensitive products. In one embodiment, the anticorrosive material such as VCI is placed on the inside of the corrugated container that is to be used to ship a corrosion-sensitive product. For examples, on the inside surface of the container and/or any build up block that may be contained therein and optionally in contact with the corrosion sensitive product. VCI products enable the release of anticorrosive materials into the air local (e.g. in the form of vapor) to where they are applied.

The anticorrosive material may be in the form of a particle. While the particle may be any size, preferably the particle is less than 50 microns. This range includes less than 0.1 micron, 0.5 micron, 1, 2, 3, 4, 5, 10, 15, 20, 25, 30, 35, 40, 45 and 50 microns, including any and all ranges and subranges therein.

The paper substrate may have any amount of the anticorrosive material present therein/thereon so long as it imparts an anticorrosive function to the substrate. The amount of anticorrosive material may be from 0.001 wt % to about 50 wt % of the total weight of the paper substrate. This range may include 0.001, 0.002, 0.005, 0.01, 0.02, 0.05, 0.1, 0.2, 0.5, 1, 2, 5, 10, 15, 20, 25, 30, 35, 40, 45, and 50 wt % based upon the total weight of the paper substrate including any and all ranges and subranges therein.

In one embodiment when the anticorrosive material is applied as a coating layer to the paper substrate, the substrate may contain any amount of the coating layer. The substrate may contain from 0.01 to 300 wet lbs/MSF of the coating layer, preferably from 0.01 to 200 wet lbs/MSF, more preferably from 0.1 to 100 wet lbs/MSF, and most preferably from 1 to 10 wet lbs/MSF of the coating layer. This range includes 0.01, 0.05, 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 125, 150, 175, 200, 225, 250, 275, and 300 wet lbs/MSF of the coating layer, including any and all ranges and subranges therein. It should be noted that the units of wet lbs/MSF can easily be converted to units of wet grams/square meters because 1 wet lbs/MSF=4.9 wet g/square meters. Therefore, from about 2 to about 10 wet lbs/MSF equals about 10 to 50 wet grams/square meter. It should further be noted that g/square meters can also be denoted as wet g/sq meters, wet g/m², etc, etc.

In another embodiment when the anticorrosive material is applied as a coating layer to the paper substrate, the substrate may contain any amount of the coating. The substrate may contain from 0.5 to 90 wt %, preferably from 1 to 80 wt %, more preferably from 1.5 to 50 wt %, most preferably from 2 to 15 wt % coating based upon the total weight of the substrate and coating combined. This range includes 0.5, 1, 1.5, 2, 2.5, 3, 3.5, 4, 4.5, 5, 6, 7, 8, 9, 10, 11, 12, 13, 14, 15, 20, 25, 30, 35, 40, 45, 50, 55, 60, 65, 70, 75, 80, 85, and 90 wt % % coating based upon the total weight of the substrate and coating combined, including any and all ranges and subranges therein.

In another embodiment, when the paper substrate of the present invention contains the anticorrosive material in the form of a coating at a portion of the substrate that will be in contact with a corrosion-sensitive product, the anticorrosive material may be present in a coating layer of the paper substrate such that the coat weight may be any coat weight as long as it imparts an anticorrosive function to the substrate. The coat weight may be such that the substrate contains at least about 50 wet grams/square meter of the coating layer at the point of contact, preferably at least about 100, more preferably from 100 to 500, most preferably from 125 to 375 wet grams/square meter of substrate. This range includes at least about 50, 75, 100, 120, 125, 150, 175, 200, 220, 250, 275, 300, 325, 350, 375, 400, 450, and 500, and wet grams/square meter of substrate, including any and all ranges and subranges therein.

The paper substrate may also contain a polymeric material. Preferably the polymeric material is a film-forming material, but may be incorporated within the paper substrate. If the polymeric material is a coating, preferably it is a component of a coating that also contains the anticorrosive material, e.g. an anticorrosive coating layer. The polymeric material may be a resin, preferably biodegradable, repulpable, and/or recyclable. The polymeric material may be any polymer and/or copolymer. Prefererably, polymeric material is a polyolefin. Examples of the polymeric material may be a resin, resin blend, polyester, polyethylene, starch, polylactic acid, polyolefin, polypropylene, polycaprolactone polymer, adipic acid, succinic acid, butanediol, terephthalic acid, polyesters of butanediol, latex, polystyrene, acrylic latex, styrene-butadiene rubber (SBR) latex, MBR latex, NBR latex, synthetic rubber latex, acrylic acid-containing polymer and copolymers, methacrylic acid-containing polymers and co-polymers, polyacrylate, polyacrylate resin latex, low density polyethylene, high density polyethylene, nylon, polycarbonates, polyethylene terephthalate, polyvinylacetate, and vinyl acetate styrene copolymers. Some preferred polymeric materials are those that are contained in commercially available products from Michelman Incorporated, Progressive Coating Inc., Northern Technologies International Corp., Spectra-kote Corporation, and Cortec Corporation, for example (e.g. VCI-350 AHS from Cortec Corporation; Rustban 250 from Michelman Incorporated; Progressive V-983 from Progressive Coatings Inc.; NTIC #6122A from Northern Technologies International Corp.; and Spectra-Guard 763-AVCI from Spectra-kote Corporation). Further examples of polymeric materials may be found in U.S. Pat. Nos. 6,833,334; 6,617,415; 6,555,600; 6,444,595; 6,420,470; 6,331,044; 6,292,996; 6,156,929; 6,132,827; 6,054,512; 6,028,160; 5,937,618; 5,896,241; 5,889,639; 5,773,105; 5,736,231; 5,715,945; 5,712,008; 5,705,566; 5,486,308; 5,391,322; 5,324,448; 5,139,700; 5,209,869; 5,344,589; 4,313,836; 4,312,768; 4,151,099; 4,101,328; 6,429,240; 6,273,993; 6,255,375; and 4,685,563, which are hereby incorporated, in their entirety, herein by reference.

Most preferably are those polymeric materials that are capable of, when placed in and/or on the paper substrate, making the paper substrate water-resistant. Such “water-resistant” polymeric materials may be the same and/or different than those polymeric materials mentioned above. Further, such water-resistant polymeric materials may be placed in and/or the paper substrate. When placed on the paper substrate, the polymeric materials may be placed, preferably on as a coating layer. This water-resistant coating layer may be the same and/or completely different than the anticorrosive-containing coating layer that may or may not contain the polymeric material mentioned above. The water-resistant polymeric materials may be acrylic based and/or those found in United States Published Patent Applications 20020182381; 20040221976, which are hereby incorporated, in their entirety, herein by reference.

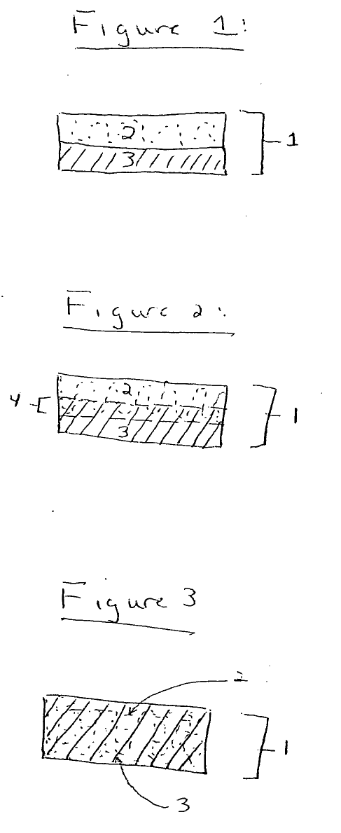

FIGS. 1-3 demonstrate different embodiments of the paper substrate 1 in the paper substrate of the present invention. FIG. 1 demonstrates a paper substrate 1 that has a web of cellulose fibers 3 and a composition containing an anticorrosive material 2 where the composition containing an anticorrosive material 2 has minimal interpenetration of the web of cellulose fibers 3. Such an embodiment may be made, for example, when an anticorrosive material is coated onto a web of cellulose fibers.

FIG. 2 demonstrates a paper substrate 1 that has a web of cellulose fibers 3 and a composition containing an anticorrosive material 2 where the composition containing an anticorrosive material 2 interpenetrates the web of cellulose fibers 3. The interpenetration layer 4 of the paper substrate 1 defines a region in which at least the anticorrosive material penetrates into and is among the cellulose fibers. The interpenetration layer may be from 1 to 99% of the entire cross section of at least a portion of the paper substrate, including 1, 2, 5, 10, 15, 20, 25, 30, 35, 40, 45, 50, 55, 60, 65, 70, 75, 80, 85, 90, 95, and 99% of the paper substrate, including any and all ranges and subranges therein. Such an embodiment may be made, for example, when an anticorrosive material is added to the cellulose fibers prior to a coating method and may be combined with a subsequent coating method if required. Addition points may be at the size press, for example.

FIG. 3 demonstrates a paper substrate 1 that has a web of cellulose fibers 3 and an anticorrosive material 2 where the anticorrosive material 2 is approximately evenly distributed throughout the web of cellulose fibers 3. Such an embodiment may be made, for example, when an anticorrosive material is added to the cellulose fibers prior to a coating method and may be combined with a subsequent coating method if required. Exemplified addition points may be at the wet end of the paper making process, the thin stock, and the thick stock.

Of course, the above-mentioned FIGS. 1-3 pertain to when the anticorrosive material is present. Such embodiments may also be appropriately suited for when a water-resistant polymeric material is utilized in addition thereto and is included in the layer containing the anticorrosive material. In an alternative embodiment, the anticorrosive material and the water-resistant polymeric material are not present in the same layer in totality, leading to the possibility of a triple layered structure (i.e. web of cellulose fibers, anticorrosive material, and water-resistant polymeric material). These layers may be contacted with one another in any order and or fashion. Further in this embodiment, the web, anticorrosive layer, and water-resistant layer may be one layer and/or may independently interpenetrate one another from 0 to 100%, respectively. The state of interpenetration for any two or more of the web, anticorrosive layer and water resistant layer may be 1, 2, 5, 10, 15, 20, 25, 30, 35, 40, 45, 50, 55, 60, 65, 70, 75, 80, 85, 90, 95, and 99% of the paper substrate, including any and all ranges and subranges therein.

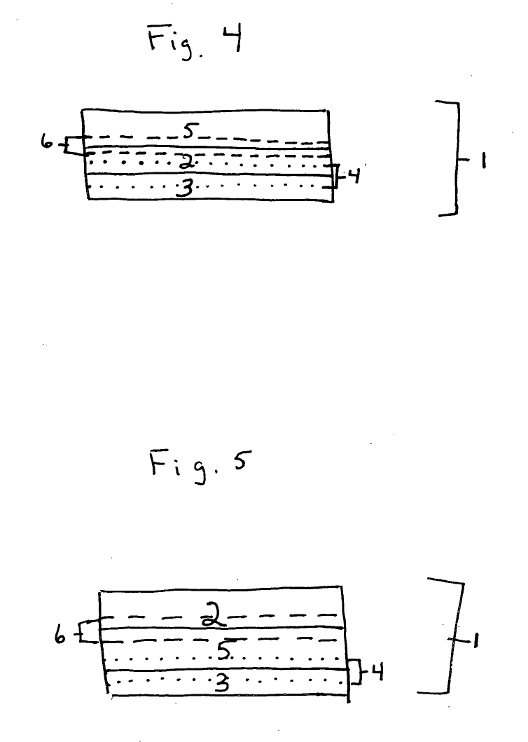

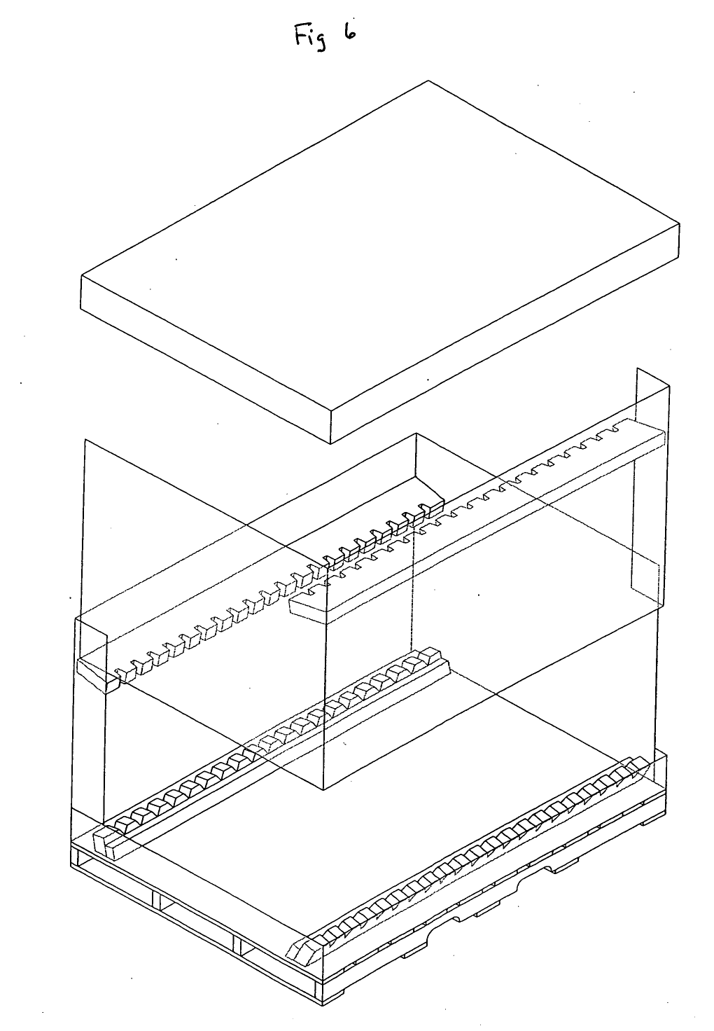

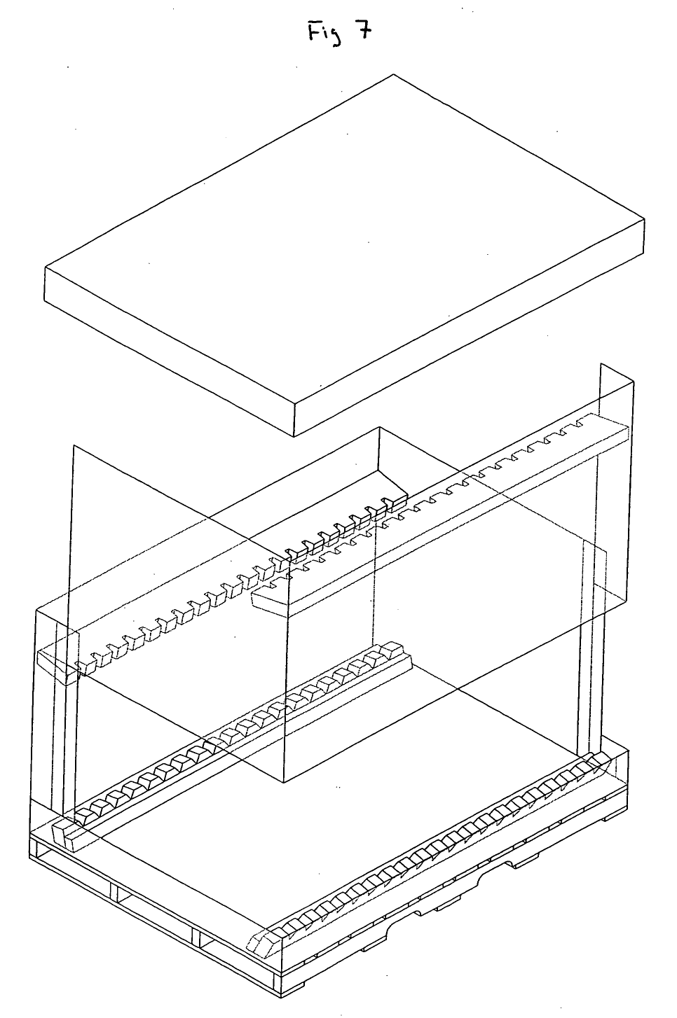

FIGS. 4 and 5 exemplify embodiments of a triple layered structure of a substrate 1 of the present invention. In FIG. 4, the web of cellulose fibers 3 and the anticorrosive material containing layer 2 may or may not contact each other via a first interpenetration layer 4. Further, the anticorrosive containing layer 2 and the water-resistance polymeric material containing layer 5 may or may not contact each other via a second interpenetration layer 6. In addition, the first interpenetration layer 4 and the second interpenetration layer 6 may optionally interpenetrate each other forming a region in which a portion of the web, a portion of the anticorrosive material, and a portion of the water-resistant polymeric material are present therein.

In FIG. 5, the web of cellulose fibers 3 and the water-resistance polymer material containing layer 5 may or may not contact each other via a first interpenetration layer 4. Further, the anticorrosive containing layer 2 and the water-resistance polymeric material containing layer 5 may or may not contact each other via a second interpenetration layer 6. In addition, the first interpenetration layer 4 and the second interpenetration layer 6 may optionally interpenetrate each other forming a region in which a portion of the web, a portion of the anticorrosive material, and a portion of the water-resistant polymeric material are present therein.

The web of cellulose fibers and the anticorrosive material may be in a multilayered structure. The thicknesses of such layers may be any thickness commonly utilized in the paper making industry for a paper substrate, a coating layer, or the combination of the two. The layers do not have to be of approximate equal size. One layer may be larger than the other. One preferably embodiment is that the layer of cellulose fibers has a greater thickness than that of any layer containing the anticorrosive material. The layer containing the cellulose fibers may also contain, in part, the anticorrosive material.

The density, basis weight and caliper of the web of this invention may vary widely and conventional basis weights, densities and calipers may be employed depending on the paper-based product formed from the web. Paper or paperboard of invention preferably have a final caliper, after calendering of the paper, and any nipping or pressing such as may be associated with subsequent coating of from about 1 mils to about 35 mils although the caliper can be outside of this range if desired. More preferably the caliper is from about 4 mils to about 30 mils, and most preferably from about 8 mils to about 25 mils. The caliper of the paper substrate with or without any coating may be 1, 2, 3, 4, 5, 6, 7, 8, 9, 10, 11, 12, 13, 14, 15, 17, 20, 22, 25, 27, 30, 32, and 35, including any and all ranges and subranges therein.

Paper substrates of the invention preferably exhibit basis weights of from about 10 lb/3000 ft² to about 500 lb/3000 ft², although web basis weight can be outside of this range if desired. More preferably the basis weight is from about 30 lb/3000 ft² to about 400 lb/3000 ft², and most preferably from about 75 lb/3000ft ² to about 300 lb/3000 ft². The basis weight may be 10, 12, 15, 17, 20, 22, 25, 30, 32, 35, 37, 40, 45, 50, 55, 60, 65, 70, 75, 80,85, 90, 95, 100, 110, 120, 130, 140, 150, 160, 170, 180, 190, 200, 225, 250, 275, 300, 325, 350, 375, 400, 425, 450, 500 lb/3000 ft², including any and all ranges and subranges therein.

The final density of the papers may be calculated by any of the above-mentioned basis weights divided by any of the above-mentioned calipers, including any and all ranges and subranges therein. Preferably, the final density of the paper substrate, that is, the basis weight divided by the caliper, is preferably from about 5 lb/3000 ft²/mil to about 17 lb/3000 ft²/mil although web densities can be outside of this range if desired. More preferably the web density is from about 7 lb/3000 ft ²/mil to about 13 lb/3000 ft²/mil and most preferably from about 9 lb/3000 ft²/mil to about 12 lb/3000 ft²/mil.

The paper substrate of the present invention may also include an antimicrobial compound in addition to and/or within any of the web, anticorrosive layer, and/or water-resistant layer mentioned above. Examples of this antimicrobial compound, as well as methods of placing this compound on paper substrates can be found, for example, in U.S. Published Patent Applications 20020182381; 20040221976, and U.S. applications having U.S. Ser. Nos. 60/585757; 11/175899; and 11/175700, which are hereby incorporated, in their entirety, herein by reference.

The web may also include other conventional additives such as, for example, starch, expandable microspheres, mineral fillers, bulking agents, sizing agents, retention aids, and strengthening polymers. Among the fillers that may be used are organic and inorganic pigments such as, by way of example, polymeric particles such as polystyrene latexes and polymethylmethacrylate, and minerals such as calcium carbonate, kaolin, and talc. Other conventional additives include, but are not restricted to, wet strength resins, internal sizes, dry strength resins, alum, fillers, pigments and dyes. Internal sizing may help prevent the surface size from soaking into the sheet, thus allowing it to remain on the surface where it has maximum effectiveness. The internal sizing agents encompass any of those commonly used at the wet end of a paper machine. These include for example starch, polyvinyl alcohol, rosin sizes, ketene dimers and multimers, and alkenylsuccinic anhydrides. The internal sizes are generally used at levels of from about 0.05 wt. % to about 0.25 wt. % based on the weight of the dry paper sheet. Methods and materials utilized for internal sizing with rosin are discussed by E. Strazdins in The Sizing of Paper, Second Edition, edited by W. F. Reynolds, Tappi Press, 1989, pages 1-33. Suitable ketene dimers for internal sizing are disclosed in U.S. Pat. No. 4,279,794, which is incorporated by reference in its entirety, and in United Kingdom Patent Nos. 786,543; 903,416; 1,373,788 and 1,533, 434, and in European Patent Application Publication No. 0666368 A3. Ketene dimers are commercially available, as Aquapel.RTM. and Precis.RTM. sizing agents from Hercules Incorporated, Wilmington, Del. Ketene multimers for use in internal sizes are described in: European Patent Application Publication No. 0629741A1, corresponding to U.S. patent application Ser. No. 08/254,813, filed Jun. 6, 1994; European Patent Application Publication No. 0666368A3, corresponding to U.S. patent application Ser. No. 08/192,570, filed Feb. 7, 1994; and U.S. patent application Ser. No. 08/601,113, filed Feb. 16, 1996. Alkenylsuccinic anhydrides for internal sizing are disclosed in U.S. Pat. No. 4,040,900, which in incorporated herein by reference in its entirety, and by C. E. Farley and R. B. Wasser in The Sizing of Paper, Second Edition, edited by W. F. Reynolds, Tappi Press, 1989, pages 51-62. A variety of alkenylsuccinic anhydrides are commercially available from Albemarle Corporation, Baton Rouge, La.

The paper substrate may be made by contacting the anticorrosive material and/or the water-resistant polymeric material with the cellulose fibers consecutively and/or simultaneously. Still further, the contacting may occur at acceptable concentration levels that provide the paper substrate of the present invention to contain any of the above-mentioned amounts of cellulose and anticorrosive material and/or the water-resistant polymeric material isolated or in any combination thereof. The contacting may occur anytime in the papermaking process including, but not limited to the thick stock, thin stock, head box, size press and coater with the preferred addition point being at the size press and/or a coating section. Further addition points include machine chest, stuff box, and suction of the fan pump. The anticorrosive material and/or the water resistant polymeric material may be coated on at least one surface of the substrate at the size press and/or using any coating apparatus. The anticorrosive material and the water-resistant polymeric material may be preformulated either together and/or in combination within a single and/or separate coating layer(s) and coated onto the fibrous web at the size press or using any coating apparatus.

Any coating apparatus may be used to apply a coating layer containing the anticorrosive and/or the water-resistant polymeric material at any coat weight, including those coat weights mentioned above. Examples of coating apparatuses include spray coating such as low volume, high pressure industrial spray coating sections, curtain coating, dip coating, roller coating, blade, air knife, rod, gravure, flexo, roll, reverse roll, size press, and Michelman coater.

The paper or paperboard of this invention can be prepared using known conventional techniques. Methods and apparatuses for forming and making and applying a coating formulation to a paper substrate are well known in the paper and paperboard art. See for example, G. A. Smook referenced above and references cited therein all of which is hereby incorporated by reference. All such known methods can be used in the practice of this invention and will not be described in detail.

The paper substrate may be made by contacting further optional substances with the cellulose fibers as well. The contacting may occur anytime in the papermaking process including, but not limited to the thick stock, thin stock, head box, size press, water box, and coater. Further addition points include machine chest, stuff box, and suction of the fan pump. The cellulose fibers, anticorrosive material and/or the water-resistant polymeric material, and/or optional components may be contacted serially, consecutively, and/or simultaneously in any combination with each other. The cellulose fibers anticorrosive material and/or the water-resistant polymeric material may be pre-mixed in any combination before addition to or during the paper-making process. In one embodiment, the optional substances are contacted with the cellulose fibers before the substrate is contacted with the anticorrosive material and/or the water-resistant polymeric material. In another embodiment, the anticorrosive material and the water-resistant polymeric material are contacted with the substrate at the same time, such as in instances when the anticorrosive material and the water-resistant polymeric material are premixed.

The paper substrate may be pressed in a press section containing one or more nips. However, any pressing means commonly known in the art of papermaking may be utilized. The nips may be, but is not limited to, single felted, double felted, roll, and extended nip in the presses. However, any nip commonly known in the art of papermaking may be utilized.

The paper substrate may be dried in a drying section. Any drying means commonly known in the art of papermaking may be utilized. The drying section may include and contain a drying can, cylinder drying, Condebelt drying, IR, or other drying means and mechanisms known in the art. The paper substrate may be dried so as to contain any selected amount of water. Preferably, the substrate is dried to contain less than or equal to 10% water.

The paper substrate may be passed through a size press, where any sizing means commonly known in the art of papermaking is acceptable. The size press, for example, may be a puddle mode size press (e.g. inclined, vertical, horizontal) or metered size press (e.g. blade metered, rod metered). At the size press, sizing agents such as binders may be contacted with the substrate. Optionally these same sizing agents may be added at the wet end of the papermaking process as needed. After sizing, the paper substrate may or may not be dried again according to the above-mentioned exemplified means and other commonly known drying means in the art of papermaking. The paper substrate may be dried so as to contain any selected amount of water. Preferably, the substrate is dried to contain less than or equal to 10% water.

The paper substrate may be calendered by any commonly known calendaring means in the art of papermaking. More specifically, one could utilize, for example, wet stack calendering, dry stack calendering, steel nip calendaring, hot soft calendaring or extended nip calendering, etc. While not wishing to be bound by theory, it is thought that the presence of the expandable microspheres and/or composition and/or particle of the present invention may reduce and alleviate requirements for harsh calendaring means and environments for certain paper substrates, dependent on the intended use thereof.

The paper substrate may be microfinished according to any microfinishing means commonly known in the art of papermaking. Microfinishing is a means involving frictional processes to finish surfaces of the paper substrate. The paper substrate may be microfinished with or without a calendering means applied thereto consecutively and/or simultaneously. Examples of microfinishing means can be found in United States Published Patent Application 20040123966 and references cited therein, as well as U.S. Ser. No. 60/810,181 filed Jun. 2, 2006, which are all hereby, in their entirety, herein incorporated by reference.

While the substrate of the present invention may be for any end use, the paper substrate of the present invention is especially useful in the context of a packaging system that is capable of carrying articles that are particularly sensitive to corrosion in the presence of high temperature, water, water vapor, air, carbon dioxide, sulfur dioxide, hydrogen sulfide, or other gases which pose a threat to surfaces of, for example, metallic objects. While metallic objects are preferred, other materials to make objects sensitive to corrosion in such atmospheres may be carried in packaging system made from the substrate of the present invention. Of course, the substrate may be used to make corrugated board first, and then be constructed into a packaging system. Alternatively, the corrugated board may be made first, and then the above-mentioned coating may be applied thereto. Any standard method of making corrugated board is appropriate for the sake of this invention.

While the paper substrate of the present invention may be incorporated into any packaging system, it is preferable that the packaging system be constructed in a manner that attempts to reduce the amount of exposure that the corrosive-sensitive article has to an environment external to the packaging system, especially if such an external environment contains high temperature, water, water vapor, air, carbon dioxide, sulfur dioxide, hydrogen sulfide, or other gases which pose a threat to surfaces of, for example, metallic objects. The use of packaging materials commonly used in the field of packaging materials that help reduce the amount of exposure that the corrosive-sensitive article has to an environment external to the packaging system, especially if such an external environment contains high temperature, water, water vapor, air, carbon dioxide, sulfur dioxide, hydrogen sulfide, or other gases which pose a threat to surfaces of, for example, metallic objects, is preferable. Such additional packaging materials may be dessicants, tape, foam, peanuts, etc. FIGS. 6 and 7 are specific examples of packaging system designs that incorporate the paper substrate of the present invention.

In one embodiment, the paper substrate is a linerboard. Further, the substrate may be incorporated into a corrugated structure; whether single, double, and/or triple-walled or more in nature. Accordingly, the substrate may be part of a corrugated structure containing at least two linerboards and at least one medium (or fluting) glued, adhered and/or laminated together. While any portion of the corrugated structure may contain the substrate of the present invention, it is preferable that an outer surface of the corrugated structure include the substrate of the present invention. The corrugated structure may be folded so as to form a packaging system for articles, preferably articles having a tendency to corrode (as mentioned above). To form the packaging system of the present invention, the corrugated structure may be folded, glued, adhered and/or laminated to itself or others like it or to conventional substrates so as to form a packaging system having an inside environment and an outside environment. While not required, it is preferable that this packaging system contains at least one surface inside the system that is constructed from the paper substrate of the present invention. An example of such a system includes a container formed from corrugated board where the linerboard of the corrugated board on the inside of the packaging system is the paper substrate of the present invention. Alternatively, the packaging system may contain an article formed from a corrugated structure inside the system where the article contains or is made from the substrate of the present invention. An example of such an article is a build up block. A build up block of any kind and for any use may is acceptable. For example, the build up block may be used to hold a product that is sensitive to corrosion in place while being transported within the packaging system or container. Therefore, the build up block may be made from the substrate of the present invention.

Accordingly, the present invention relates to a packaging system including a container made from corrugated structure and an article, such as a build up block, made of a paper. The corrugated structure and/or the article may contain the substrate of the present invention. Preferably, both the corrugated structure and the article contain the substrate of the present invention. When the article contains the substrate of the present invention, the entire outer surface of the article contains the substrate such that the coating layer of the substrate is on the outside of the article. The article may contain the substrate of the present invention at least at the points of contact with the product that is sensitive to corrosion and is to be packaged in the system such that the coating layer of the substrate is on the outside of the article and is in contact with the product. In the embodiment where both the corrugated structure and the article contain the substrate of the present invention, any amount of the coating may be present. For example, the coating may be present on a surface of a linerboard at the same amount as that of the surface of the article, such as a build up block, that will be in contact with the corrosive-sensitive product. Alternatively, the coating may be present on a surface of a linerboard at a different amount than that of the surface of the article, such as a build up block, that will be in contact with the corrosive-sensitive product. In such instances, it is preferred that the linerboard paper substrate of the corrugated structure have a coating at an amount that is less than the amount of coating present on the article such as the build up block. The amounts of the coating may be any one or more of those mentioned above in describing the paper substrate of the present invention.

The corrugated structures that include at least two linerboards and at least one medium (or fluting) may have any combined basis weight. The corrugated structures that include at least two linerboard and at least one medium (or fluting) may have any combined basis weight of from 80 lb/MSF to 600 lb/MSF. This range includes 80, 90, 100, 110, 120, 130, 140, 150, 160, 170, 180, 190, 200, 210, 220, 230, 240, 250, 260, 270, 280, 290, 300, 310, 320, 350, 375, 400, 425, 450, 475, 500, 525, 550, 575, and 600 lb/MSF, including any and all ranges and subranges thereof.

An example of a build up block is any article made in whole or in part from a paper substrate, preferably a corrugated paper structure. The corrugated structure may have any basis weight and may be single, double, and triple walled or more. An example may be 133 lb/msf. These basis weights have been described previously. Also, the dimensions of the build up block may be any dimension so long as it holds the product to be shipped (and may be corrosive-sensitive) in place.

FIGS. 6 and 7 show embodiments of a packaging system made from a corrugated structure incorporating the substrates of the present invention and a build up block contained therein. While any packaging system is appropriate, it is preferred that the packaging system be as closed off to the outside environment as possible. That is, that the packaging system reduces the exposure of the products within the package to the environment outside the package.

The present invention is explained in more detail with the aid of the following embodiment example which is not intended to limit the scope of the present invention in any manner.

### EXAMPLES

### Example 1

To assist in the development of a corrosion resistant container for use as packaging of corrosive sensitive materials (for example, automotive parts), three anticorrosion materials (in this instance vapor corrosion inhibitors) were compared when spray applied to the interior of corrugated packaging and compared with an untreated container and one using only a commercial anticorrosion-resistant plastic bag such as those sold under the trademark Zerust® by NTIC (Northern Technologies International Corp.). Both carbon steel (C1020) and aluminum (AL 6061) corrosion coupons were placed in each of the sealed containers for two weeks at 90% Relative Humidity/100° F. in an environmental chamber and then examined using an optical microscope. The results are that the liquid anticorrosion treatments gave substantial improvement in corrosion resistance for carbon steel compared to both the untreated control and those coupons placed in the sealed plastic bag. The aluminum coupons did not show any corrosion given this exposure history.

TESTING PROCEDURE

One cubic foot corrugated containers were obtained and a section of a built-up-block (BUB) was placed at the bottom of each box. The BUB is a laminated structure of several layers of triple-wall corrugated board used to cushion the automotive parts. The boxes with the three treatments were prepared by spraying the target dosage of each chemical uniformly within the box interior and the outer surface of the BUB. The target dosage was verified using a scale. The boxes were allowed to air dry at TAPPI standard conditions (50% Relateive Humidity, 73 degrees F.). To guarantee that the entire fluted surface of the BUB was coated with a film of the anticorrosion material, the top surface of the BUB was then immersed for a few seconds in a thin layer of VCI liquid followed by drying of the BUB in a 150 degrees F. oven for 3 hours.

Corrosion coupons (C1020 and AL6061 from Metal Samples Co., Alabama Laser Technologies) were obtained and prepared for testing by washing with Alconox detergent followed by thorough drying using compressed air. The coupons were handled at all times with latex gloves to prevent any contamination by finger oils. An “X” was inscribed on the face of each coupon with a knife to present fresh surface for corrosion to form. Three coupons of each type were attached to the top of the BUB using plastic cable ties inserted through the holes of the coupons. In all cases, the numbered side of the coupon was mounted facing upwards towards the box interior and the vapor phase) and the unnumbered side was placed in contact with the BUB.

In addition to the three containers which were treated, one container was used as a control which had no applied treatment to either the box walls or the BUB. Another untreated box was used to test metal parts placed within the sealed treated plastic bag, which is the current method of protection used by automotive manufacturers. Two treated bags supplied by Northern Technologies were used to contain two corrosion coupons of each metal type.

The containers were thoroughly sealed with packaging tape at all seams and placed that same afternoon in an environmental chamber. The chamber was controlled at 90% Relative Humidity and 100 degrees F. for two weeks. At the conclusion of the exposure, the boxes were removed and were transported in a sealed condition. The boxes were placed in TAPPI standard conditions for 2 hours before opening. Photographs were taken of the corrosion coupons and an optical microscope was used to examine the fine features of the surface of each coupon.

COMPARISON OF ANTICORROSION MATERIALS

The anticorrosion materials selected were for multiple metal types including steel. Table 1 compares each of these liquid treatment materials:

TABLE 1
CHEMICALS SELECTED FOR INITIAL TESTING

| | | Solids | Coat Weight | |
|---|---|---|---|---|
| | | Content | (Wet | Application |
| Supplier | Product | (%) | Lb/MSF) | Methods |
| Cortec | VpCI | 27-32 | 2.0 to 3.0, | Apply to |
| | 350 | | with more | board using |
| | AHS | | used for | various |
| | | | warm and | coaters, |
| | | | humid | press or |
| | | | conditions | spray; dry |
| | | | (trial used | using |
| | | | 4.0) | ambient or |
| | | | | hot air |
| | | | | (flash point |
| | | | | 200 F.). |
| Michelman | Rustban | 40-50 | At least 3.5 | Apply to |
| | 250 | | (trial used | board using |
| | | | 4.0) | various |
| | | | | coaters or |
| | | | | spray; dry |
| | | | | using |
| | | | | ambient or |
| | | | | hot air. |
| Spectra-Kote | Spectra- | 36 | 2.0 to 8.0, | Apply to |
| | Guard | | depending on | board using |
| | 763 | | Application | various |
| | AVCI | | (trial used | coaters, |
| | | | 6.0) | press or |
| | | | | spray; |
| | | | | requires hot |
| | | | | air to cure |
| | | | | product. |

ANTICORROSIVE PERFORMANCE RANKING FOR REDUCING THE CORROSIVENESS OF NON-CONTACTING METAL SURFACES IN THE PACKAGE (I.E. REGARDING SURFACES OF THE METAL THAT WERE NOT CONTACTED WITH A PAPER SUBSTRATE CONTAINING THE ANTICORROSIVE MATERIAL)

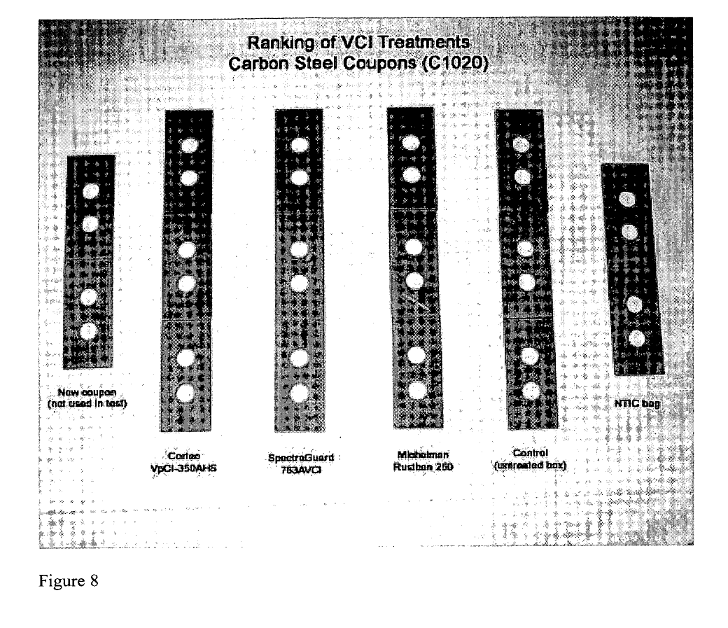

FIG. 8 shows top surfaces of all C1020 coupons used in actual tests compared to new coupons (far left) placed in order from least to greatest corrosion (left to right). The only corrosion observed on the coupons placed in the treated boxes appears near the holes where the plastic cable ties were inserted to fasten to the built-up-blocks.

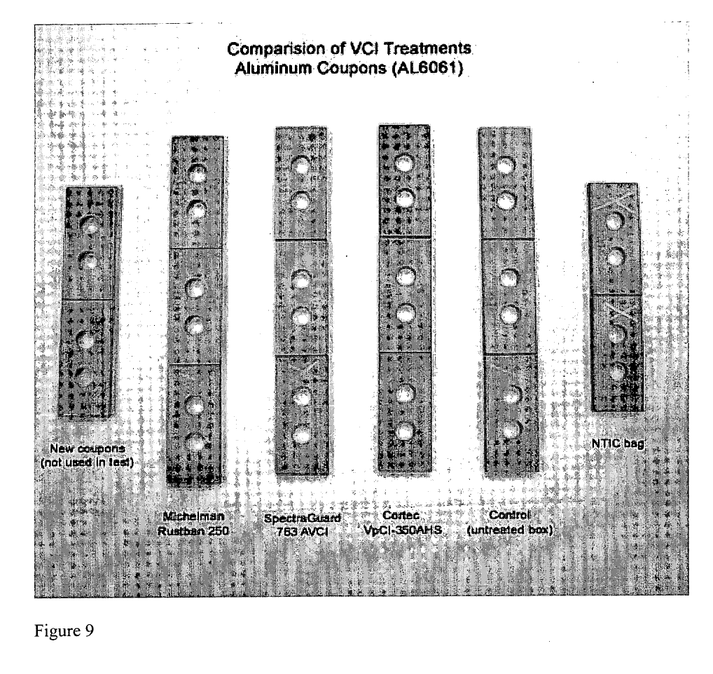

FIG. 9 shows top surfaces of all AL6061 coupons used in actual tests compared to new coupons (far left). There was no corrosion noted on any of the aluminum coupons during this exposure. AL 6061 is fairly resistant to oxidation.

Each of the three anticorrosion chemistries provided significant protection against corrosion for carbon steel surfaces not in contact with the paper substrate (treated or untreated) given the hot and humid box conditions.

Surprisingly, it should be noted that surfaces of the coupons in contact with the BUB (whether treated or untreated) did show a tendency to corrode, even in instances where the surfaces of the coupons not in contact with the BUB did not corrode. Further, there was more of a tendency to corrode in instances when the BUB is untreated than when the BUB was treated.

### Example 2

TESTING PROCEDURE

One cubic foot corrugated containers were obtained to house a section of built-up-block (BUB) that was treated according to the procedures below. The BUB is a laminated structure of several layers of triple wall, or greater walled, corrugated board used to cushion the automotive parts. In this study, only the top surface of the BUB (2.75-inches by 10-inches) that is in direct contact with the corrosion coupons was treated.

A conventional paint roller (3-inch wide foam with a nap ⅜-inch thick) was used to apply the various chemical treatments in several passes to the exposed face of the build up block (BUB), with the dosages measured using a scale. A minimum of a low, medium and high dosage were applied to the top exposed surface of the BUB and the treatments were then allowed to dry overnight at TAPPI standard conditions (50% relative humidity, 73 degrees F.). See Table 2 for dosages of each treatment chemical applied to the BUB.

TABLE 2

| | | | Application |
|---|---|---|---|
| Box and BUB | | Mass of chemical | dosage (wet |
| No. and Nominal | Treatment | applied (wet | grams/sq |
| Dosage | Chemical | grams) | meter) |
| CTRL | Control— | 0.00 | 0.00 |
| | Untreated BUB | | |
| C2 (Low) | Cortec VPCi 350 | 3.11 | 175 |
| | AHS | | |
| C4 (Medium) | Cortec VPCi 350 | 5.95 | 335 |
| | AHS | | |
| C3 (High) | Cortec VPCi 350 | 7.06 | 398 |
| | AHS | | |
| N1 (Low) | NTIC #6122A | 3.12 | 176 |
| N4 (Medium) | NTIC #6122A | 5.30 | 299 |
| N2 (High) | NTIC #6122A | 6.70 | 378 |
| P1 (Very Low) | Progressive | 2.15 | 121 |
| | V-983 | | |
| P4 (Low) | Progressive | 3.98 | 224 |
| | V-983 | | |
| P3 (Medium) | Progressive | 5.20 | 293 |
| | V-983 | | |
| P2 (High) | Progressive | 7.07 | 399 |
| | V-983 | | |
| S2 (Low) | SpectraGuard 763 | 3.19 | 180 |
| | AVCI | | |
| S4 (Medium) | SpectraGuard 763 | 5.40 | 304 |
| | AVCI | | |
| S7 (High) | SpectraGuard 763 | 6.97 | 393 |
| | AVCI | | |

Carbon steel corrosion coupons (C1020 from Metal Samples Co., Alabama Laser Technologies) were obtained and prepared for testing by washing off the residual chemicals from their packaging with Alconox detergent and immediate rinsing with deionized water and drying using lint-free cloths (AB Dick, #4-4940, Clean Free Disposable Shop Cloths). The coupons were handled at all times with latex gloves to prevent contamination by finger oils.

For each box, three C1020 corrosion coupons were assigned randomly, and were mounted snuggly to the treated face of the BUB by threading plastic cable ties through the holes in each coupon and the corrugated flutes of the BUB. In all cases, the numbered side of the coupon was mounted facing upwards towards the box interior and the vapor phase and the unnumbered side was placed in contact with the BUB. In this study, the interior of the box walls was not treated with the chemicals, only the top face of the BUB was which was in contact with the bottom surface of each corrosion coupon. An assembly of the three coupons on each BUB was then placed inside each box and held in place by a friction fit of the BUB inside the box interior. A total of 13 sections of BUB were treated and there was one untreated BUB used as a control.

The containers were thoroughly sealed with packaging tape at all seams and were shipped from the laboratory in Loveland, Ohio overnight for placement the next day in an environmental chamber at a laboratory facility in Memphis, Tenn. The boxes were exposed for 21 days to controlled conditions of 90% relative humidity and 100 degrees F. At the conclusion of the exposure, the boxes were removed from the chamber and shipped overnight in a sealed condition back to Loveland, Ohio where they were opened and examined the next day at TAPPI standard conditions. Photographs were taken of both sides of the corrosion coupons to document their surface condition and extent of corrosion.

COMPARISON OF TREATMENTS AND PERFORMANCE

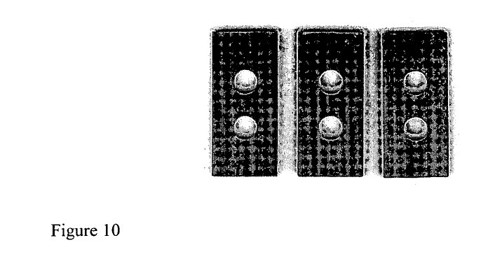

FIGS. 10-15 show the bottom surfaces of the corrosion coupons which were in direct contact with the face of the treated BUB.

FIG. 10 shows images of the face of corrosion coupons in Control (untreated BUB) box in direct contact with BUB. There is variability in the degree of corrosion from coupon-to-coupon probably due to different levels of condensation experienced on the face of each coupon and BUB. The degree of corrosion on the face of the rightmost coupon is the worst of all coupons in this study. Coupon numbers from left to right are #7, 19 and 25.

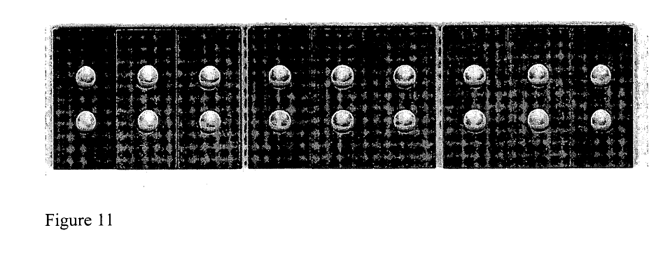

FIG. 11 shows images of faces of corrosion coupons grouped by threes into dosage levels of the Cortec VPCi 350 AHS treatment. Coupon numbers from left to right are (Low dosage, #13, 35, 36; Medium dosage, #27, 32, 34; High dosage, #8, 26, 30). The faces of the corrosion coupons show very little corrosion, with 2 spots evident in the low dosage grouping and one spot evident in the high dosage grouping. Cortec provides a degree of protection of the metal in contact with the BUB.

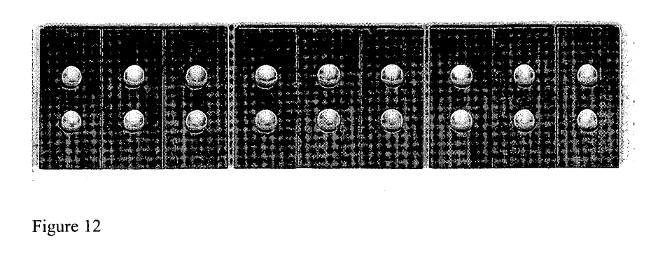

FIG. 12 shows images of faces of corrosion coupons grouped by threes into dosage levels of the NTIC #61222A treatment. Coupon numbers from left to right are (Low dosage, #11, 14, 24; Medium dosage, #5, 23, 42; High dosage, #15, 37, 39). A considerable amount of corrosion appears on the faces of the coupons that were in direct contact with the treated surface of the BUB. The degree of corrosion increases with the dosage level of the NTIC material for some reason. The NTIC chemistry does not offer protection in a direct contacting scenario.

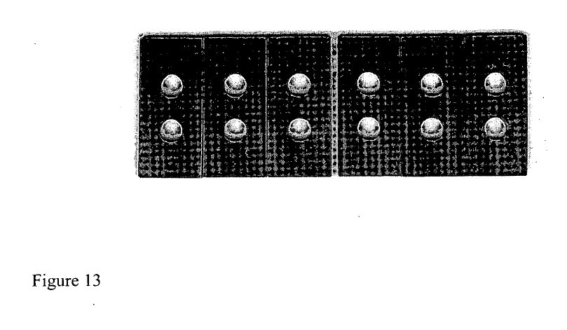

FIG. 13 shows images of faces of corrosion coupons grouped by threes into the two lower dosage levels of the Progressive #V-983 treatment. Coupon numbers from left to right are (Very low dosage, #3, 12, 17; Low dosage, #2, 4, 20). A minor amount of corrosion is observed on these coupons with several spots of corrosion present.

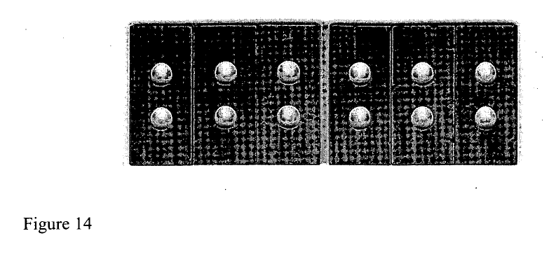

FIG. 14 shows images of faces of corrosion coupons grouped by threes into the two higher dosage levels of the Progressive #V-983 treatment. Coupon numbers from left to right are (Medium dosage, #10, 18, 31; High dosage, #22, 33, 41). There is corrosion evident on these coupons. By comparison with the coupons at the two lower dosages in

FIG. 4, it appears that degree of corrosion increases as the dosage of the Progressive treatment increases. The Progressive chemistry does not offer protection in a direct contacting scenario.

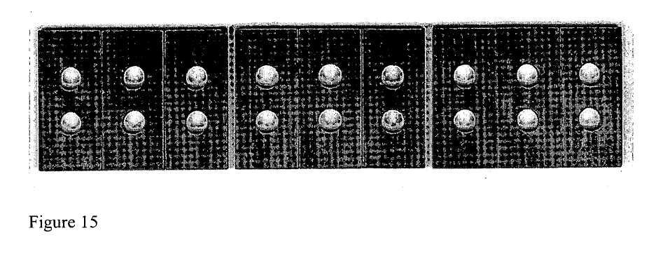

FIG. 15 shows images of faces of corrosion coupons grouped by threes into dosage levels of the SpectraGuard 763 AVCI treatment. Coupon numbers from left to right are (Low dosage, #9, 16, 38; Medium dosage, #28, 29, 40; High dosage, #1, 6, 21). The faces of the corrosion coupons show the least corrosion of all treatments, with only 3 spots evident in the low dosage grouping. The SpectraGuard material which contains an acrylic polymer forms a film on the exposed fluted surface of the BUB which acts as a protective barrier layer. This treatment gives the best performance in a scenario where the metal is in direct contact with corrugated board.

It should be noted that while the surfaces of the coupons not in contact with the treated BUB did not show some corrosion, such-surfaces in the control did show much more corrosion thereon.

Numerous modifications and variations on the present invention are possible in light of the above teachings. It is, therefore, to be understood that within the scope of the accompanying claims, the invention may be practiced otherwise than as specifically described herein.

As used throughout, ranges are used as a short hand for describing each and every value that is within the range, including all subranges therein.

All of the references, as well as their cited references, cited herein are hereby incorporated by reference with respect to relative portions related to the subject matter of the present invention and all of its embodiments

What is claimed is:

1. A paper substrate, comprising
a web of cellulose fibers; and
from 1 to 10 wet lbs/MSF of a coating composition that interpenetrates the web of cellulose fibers from about 0 to about 100% based on the cross section of the web, wherein said coating comprises an anticorrosive material and optionally a film-forming material.

2. The paper substrate according to claim 1, wherein the film forming material is at least one member selected from the group comprising a resin, resin blend, polyester, polyethylene, starch, polylactic acid, polyolefin, polypropylene, polycaprolactone polymer, adipic acid, succinic acid, butanediol, terephthalic acid, polyesters of butanediol, latex, polystyrene, acrylic acid-containing polymer and copolymers, methacrylic acid-containing polymers and co-polymers, polyacrylate, polyacrylate resin latex, low density polyethylene, high density polyethylene, nylon, polycarbonates, and polyethylene terephthalate.

3. The paper substrate according to claim 2, wherein the anticorrosive material is at least one member selected from the group consisting of amine salts, ammonium benzoate, alkali molybdates, alkali nitrites, alkali dibasic acid salts, triazole-containing compounds, sodium molybdate, dicyclohexylammonium nitrate, sodium nitriate, cyclohexylammonium benzoate, ethanol ammonium benzoate, benzotriazole, triethanolammonium nitrate, sodium sebacate, tolytriazole, tall oil imidazoline acetate, tall oil imidazoline nitrate, cyclohexyammonium p-nitro benzoate, ammonium salt of sebacic acid, monoethanolammonium benzoate, potassium molybdate, lauric diethanolamide, and ammonium salts.

4. The paper substrate according to claim 1, comprising from 2 to 4 wet lbs/MSF of the coating composition.

5. The paper substrate according to claim 4, wherein the film forming material is at least one member selected from the group comprising a resin, resin blend, polyester, polyethylene, starch, polylactic acid, polyolefin, polypropylene, polycaprolactone polymer, adipic acid, succinic acid, butanediol, terephthalic acid, polyesters of butanediol, latex, polystyrene, acrylic acid-containing polymer and copolymers, methacrylic acid-containing polymers and co-polymers, polyacrylate, polyacrylate resin latex, low density polyethylene, high density polyethylene, nylon, polycarbonates, and polyethylene terephthalate.

6. The paper substrate according to claim 4, wherein the anticorrosive material is at least one member selected from the group consisting of amine salts, ammonium benzoate, alkali molybdates, alkali nitrites, alkali dibasic acid salts, triazole-containing compounds, sodium molybdate, dicyclohexylammonium nitrate, sodium nitriate, cyclohexylammonium benzoate, ethanol ammonium benzoate, benzotriazole, triethanolammonium nitrate, sodium sebacate, tolytriazole, tall oil imidazoline acetate, tall oil imidazoline nitrate, cyclohexyammonium p-nitro benzoate, ammonium salt of sebacic acid, monoethanolammonium benzoate, potassium molybdate, lauric diethanolamide, and ammonium salts.

7. The paper substrate according to claim 1, wherein the substrate has a basis weight of from 75 lb/3000 ft² to about 300 lb/3000 ft²

8. The paper substrate according to claim 7, wherein the paper substrate is a linerboard.

9. A corrugated structure comprising at least one paper substrate according to claim 8 and a medium therebetween, wherein the combined basis weight of the corrugated structure is from 80 lb/MSF to 600 lb/MSF.

10. A container comprising the corrugated structure according to claim 9.

11. The container according to claim 10, wherein the corrugated structure defines the walls of the container forming an interior environment and an outside environment such that the coating of the linerboard is located and exposed to the inside environment of the container.

12. The container according to claim 11, further comprising a build up block located within the interior environment of the container.

13. The container according to claim 12, wherein a portion of the build up block comprises a paper substrate.

14. The container according to claim 12, wherein a portion of the build up block is constructed from a paper substrate comprising
a web of cellulose fibers and from 125 to 375 wet grams/square meter of a coating composition that interpenetrates the web of cellulose fibers from about 0 to about 100%, wherein said coating comprises an anticorrosive material and optionally a film-forming material.

15. The container according to claim 14, wherein the coating composition is on a portion of an outside surface of the build up block.

16. The container according to claim 15, wherein the coating composition on the outside surface of the build up block and the coating on the inside surface of the container is the same.

17. The container according to claim 15, wherein the coating composition on the outside surface of the build up block and the coating on the inside surface of the container is different.

18. The container according to claim 17, wherein the build up block comprises a paper substrate comprising from 200 to 300 wet grams/square meter of the coating composition.

19. The container according to claim 17, wherein the linerboard used to make the corrugated structure that forms the walls of the container comprises from 2 to 4 wet lbs/msf of the coating composition.

20. The container according to claim 19, wherein the build up block comprises
a paper substrate comprising from 200 to 300 wet grams/square meter of the coating composition.
